(19) United States
(12) Patent Application Publication
(10) Pub. No.: US 2025/0056561 A1
(43) Pub. Date: Feb. 13, 2025

(54) UPLINK CONTROL SIGNALING FOR MULTIPLE SERVING CELLS

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/786,392

(22) Filed: Jul. 26, 2024

Related U.S. Application Data
(60) Provisional application No. 63/531,275, filed on Aug. 7, 2023.

(51) Int. Cl. H04W 72/232

(52) U.S. Cl. CPC H04W 72/232

(57) ABSTRACT

Apparatuses and methods for uplink (UL) control signaling for multiple serving cells. A method includes receiving first information for a first set of operation states for first one or more cells, second information for a second set of operation states for second one or more cells, and third information for a resource for transmission of a channel. An operation state from the first set of operation states or the second set of operation states is associated with sets of parameters for transmissions or receptions in at least one of time, frequency, and spatial domains. The method further includes determining one or more first operation states from the first set of operation states and one or more second operation states from the second set of operation states and transmitting the channel using the resource. The channel indicates the one or more first and second operation states.

### CROSS-REFERENCE TO RELATED AND CLAIM OF PRIORITY

The present application claims priority under 35 U.S.C. § 119(e) to U.S. Provisional Patent Application No. 63/531,275 filed on Aug. 7, 2023, which is hereby incorporated by reference in its entirety.

### TECHNICAL FIELD

The present disclosure relates generally to wireless communication systems and, more specifically, the present disclosure is related to apparatuses and methods for uplink (UL) control signaling for multiple serving cells.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to uplink control signaling for multiple serving cells.

In an embodiment, a user equipment (UE) is provided. The UE includes a transceiver configured to receive first information for a first set of operation states for first one or more cells, second information for a second set of operation states for second one or more cells, and third information for a resource for transmission of a channel. An operation state from the first set of operation states or the second set of operation states is associated with sets of parameters for transmissions or receptions in at least one of time, frequency, and spatial domains. The UE further includes a processor operably coupled to the transceiver. The processor is configured to determine one or more first operation states from the first set of operation states and one or more second operation states from the second set of operation states. The transceiver is further configured to transmit the channel using the resource. The channel indicates the one or more first operation states and the one or more second operation states.

In another embodiment, a base station (BS) is provided. The BS includes a transceiver configured to transmit first information for a first set of operation states for first one or more cells, second information for a second set of operation states for second one or more cells, and third information for a resource for reception of a channel. An operation state from the first set of operation states or the second set of operation states is associated with sets of parameters for receptions or transmissions in at least one of time, frequency, and spatial domains. The BS further includes a processor operably coupled to the transceiver. The processor is configured to determine one or more first operation states from the first set of operation states and one or more second operation states from the second set of operation states. The transceiver is further configured to receive the channel using the resource. The channel indicates the one or more first operation states and the one or more second operation states.

In yet another embodiment, a method is provided. The method includes receiving first information for a first set of operation states for first one or more cells, second information for a second set of operation states for second one or more cells, and third information for a resource for transmission of a channel. An operation state from the first set of operation states or the second set of operation states is associated with sets of parameters for transmissions or receptions in at least one of time, frequency, and spatial domains. The method further includes determining one or more first operation states from the first set of operation states and one or more second operation states from the second set of operation states and transmitting the channel using the resource. The channel indicates the one or more first operation states and the one or more second operation states.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIGS. 6A and 6B illustrate an example of a transmitter and receiver structures using

orthogonal frequency division multiplexing (OFDM) according to embodiments of the present disclosure;

FIGS. 7A and 7B illustrate a flow diagram of an encoding and decoding processes for downlink control information (DCI) according to embodiments of the present disclosure;

FIG. 8 illustrates a flowchart of an example UE procedure for transmitting uplink signals/channels indicating state transition request (STR) information on subsets of serving cells according to embodiments of the present disclosure;

FIG. 9 illustrates a flowchart of an example UE procedure for transmitting a physical uplink control channel (PUCCH) indicating STR information to a serving cell according to embodiments of the present disclosure;

FIG. 10 illustrates a flowchart of an example UE procedure for transmitting a PUCCH indicating STR information to a set of activated serving cells according to embodiments of the present disclosure;

FIG. 11 illustrates a flowchart of an example UE procedure for transmitting a PUCCH indicating STR information to a deactivated cell according to embodiments of the present disclosure;

FIG. 12 illustrates a flowchart of an example UE procedure for transmitting a physical uplink shared channel (PUSCH) indicating STR information according to embodiments of the present disclosure;

FIG. 13 illustrates a timeline of an example relationship for PUCCH transmissions and physical downlink control channel (PDCCH) monitoring occasions according to embodiments of the present disclosure; and

FIG. 14 illustrates a flowchart of an example UE procedure for transmitting STR reporting including a DCI format indicating STR information according to embodiments of the present disclosure.

### DETAILED DESCRIPTION

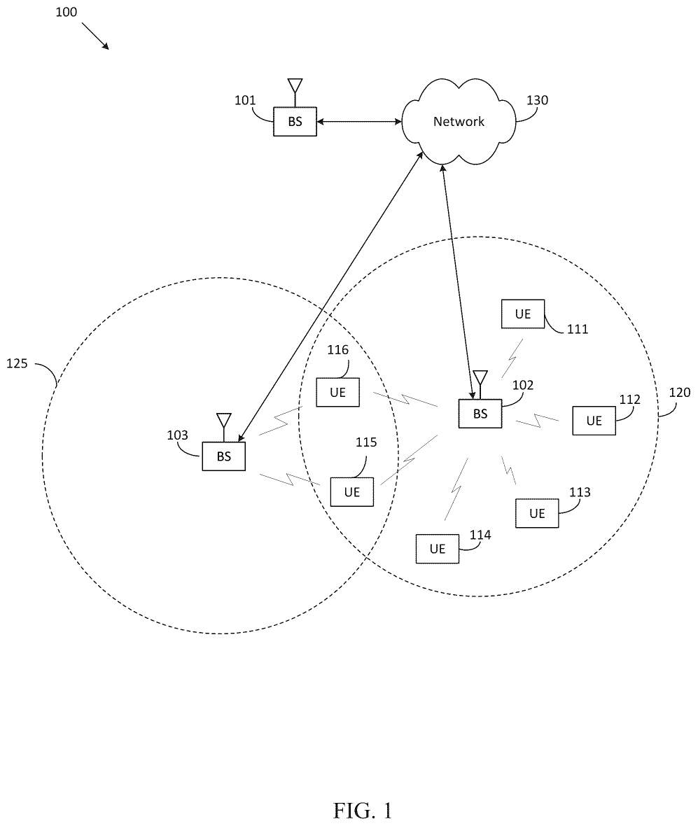

FIGS. 1-14, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G , or even later releases which may use terahertz (THz) bands.

The following documents and standards descriptions are hereby incorporated by reference into the present disclosure as if fully set forth herein: [1] 3GPP TS 38.211 v17.6.0, “NR; Physical channels and modulation;” [2] 3GPP TS 38.212 v17.6.0, “NR; Multiplexing and channel coding;” [3] 3GPP TS 38.213 v17.6.0, “NR; Physical layer procedures for control;” [4] 3GPP TS 38.214 v17.6.0, “NR; Physical layer procedures for data;” [5] 3GPP TS 38.321 v17.5.0, “NR; Medium Access Control (MAC) Protocol Specification;” and [6] 3GPP TS 38.331 v17.5.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally regarded as a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for uplink control signaling for multiple serving cells. In certain embodiments, one or more of the BSs 101-103 include circuitry, programing, or a combination thereof to support determination of uplink control signaling for multiple serving cells.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

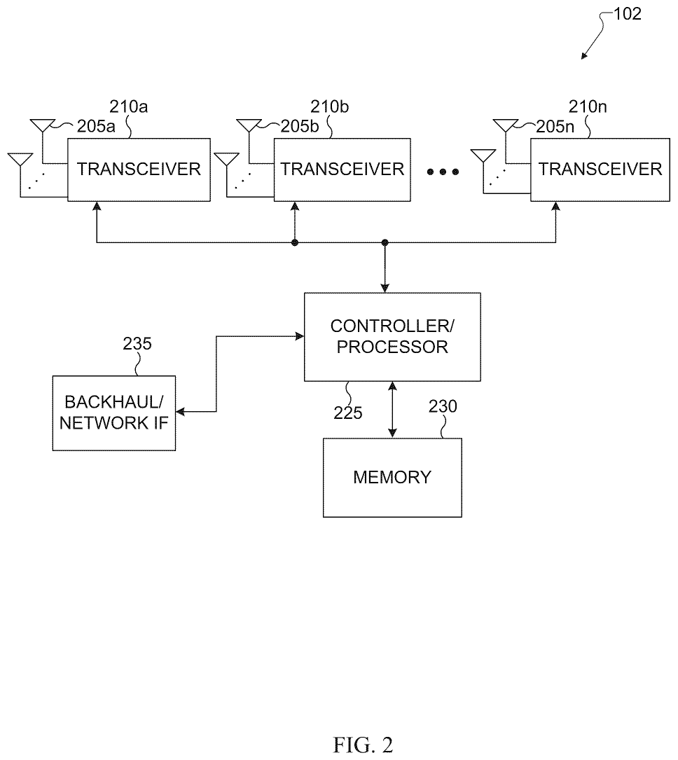

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for providing uplink control signaling for multiple serving cells. Any of a wide variety of other functions could be supported in the gNB 102 by the controller/processor 225.

The controller/processor 225 is also capable of executing programs and other processes resident in the memory 230, such as processes for supporting uplink control signaling for multiple serving cells. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

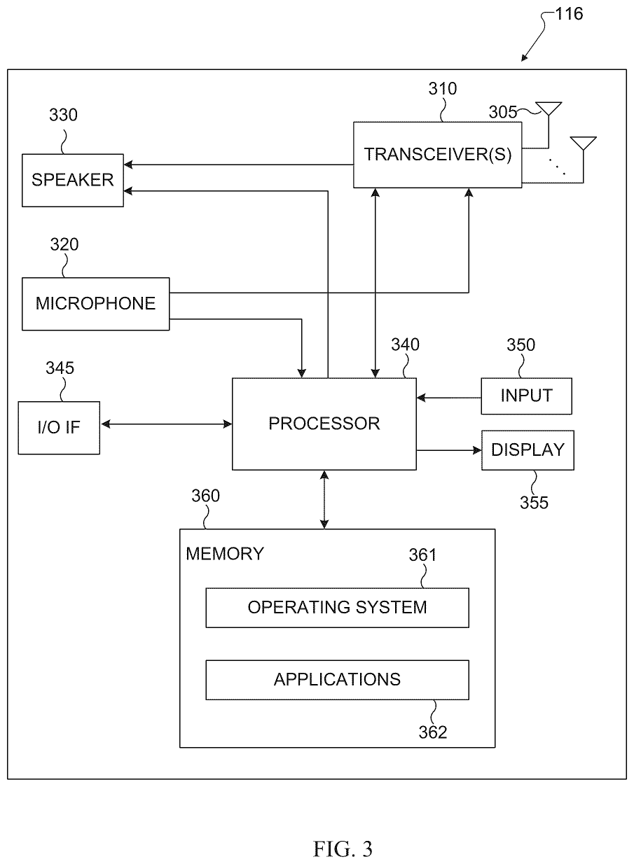

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for uplink control signaling for multiple serving cells as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

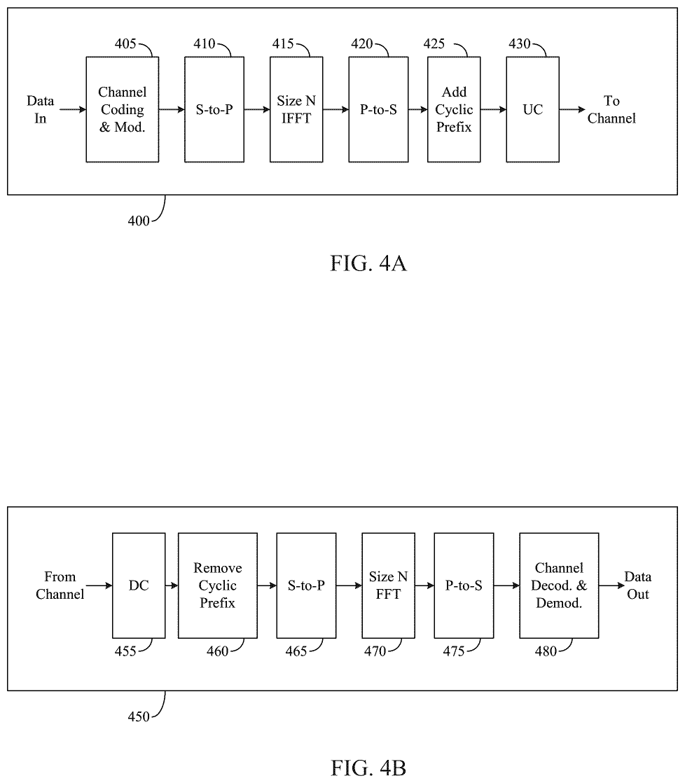

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for uplink control signaling for multiple serving cells as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

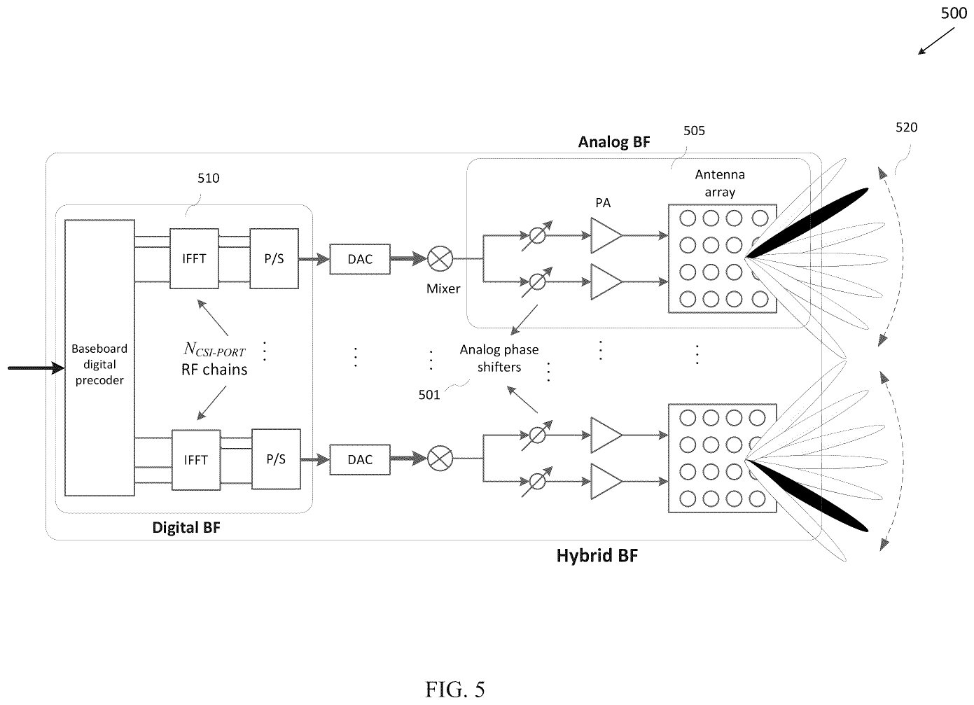

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}. 15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 [REF1] v17.4.0, “NR; Physical channels and modulation”, and 3GPP TS 38.213 [REF3] v17.4.0 “NR; Physical Layer procedures for control”.

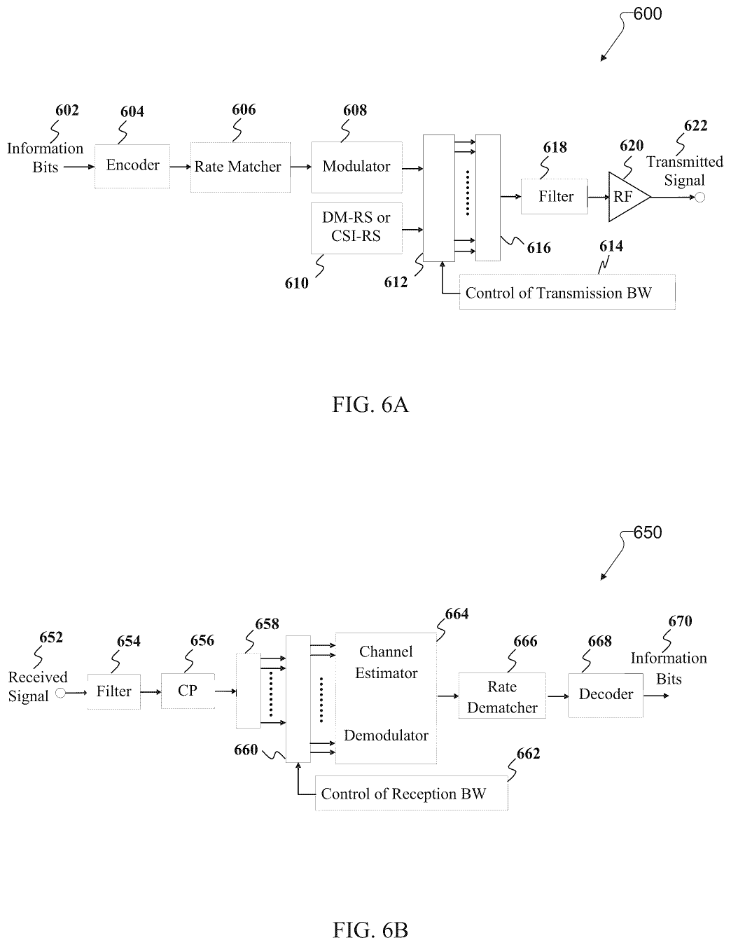

FIG. 6A and 6B illustrate an example of transmitter and receiver structures 600 and 650, respectively, using OFDM according to embodiments of the present disclosure. For example, a transmit structure 600 may be described as being implemented in a gNB (such as gNB 102), while a receive structure 650 may be described as being implemented in a UE (such as UE 116). This example is for illustration only and other embodiments can be used without departing from the scope of the present disclosure.

Information bits, such as DCI bits or data bits 602, are encoded by encoder 604, rate matched to assigned time/frequency resources by rate matcher 606 and modulated by modulator 608. Subsequently, modulated encoded symbols and demodulation reference signal (DMRS) or CSI-RS 610 are mapped to REs 612 by RE mapping unit 614, an inverse fast Fourier transform (IFFT) is performed by filter 616, a cyclic prefix (CP) is added by CP insertion unit 618, and a resulting signal is filtered by filter 620 and transmitted by a radio frequency (RF) unit 622.

A received signal 652 is filtered by filter 654, a CP removal unit removes a CP 656, a filter 658 applies a fast Fourier transform (FFT), RE de-mapping unit 660 de-maps REs selected by BW selector unit 662, received symbols are demodulated by a channel estimator and a demodulator unit 664, a rate de-matcher 666 restores a rate matching, and a decoder 668 decodes the resulting bits to provide information bits 670.

DCI can serve several purposes. A DCI format includes a number of fields, or information elements (IEs), and is typically used for scheduling a PDSCH (DL DCI format) or a physical uplink shared channel (PUSCH) (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with radio resource control (RRC) connection to a gNB, the RNTI is a cell RNTI (C-RNTI) or another RNTI type such as a modulation and coding scheme (MCS)-C-RNTI. For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access RNTI (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a Transmit Power Control (TPC)-RNTI, and so on. Each RNTI type is configured to a UE through higher layer signaling. A UE typically decodes at multiple candidate locations for potential PDCCH receptions as determined by an associated search space set

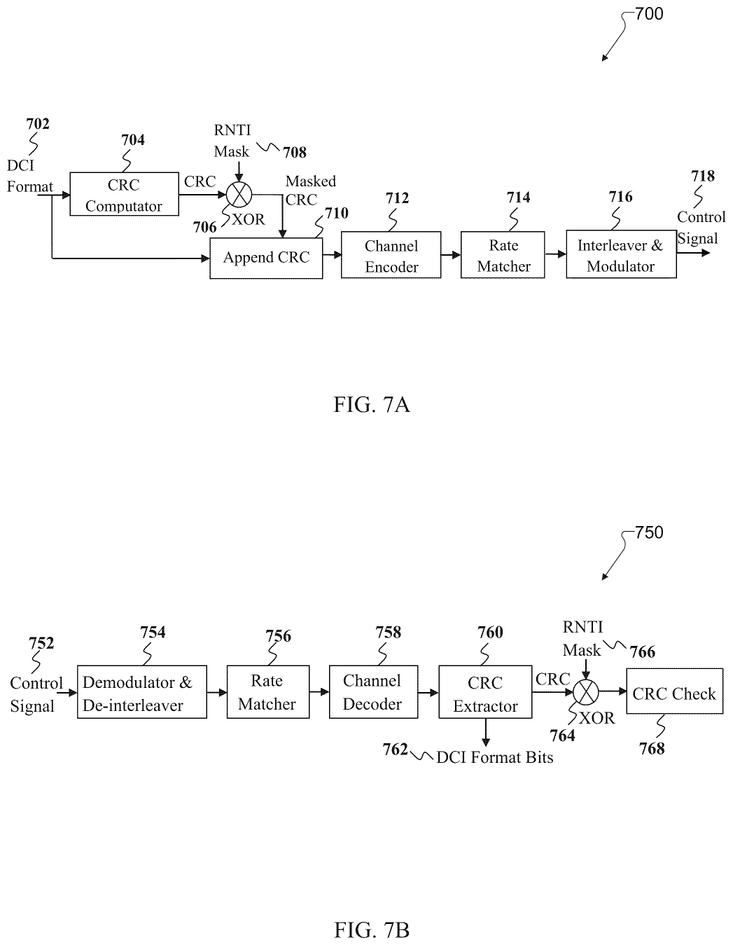

FIG. 7A and 7B illustrate an example of an encoding and decoding processes 700 and 750, respectively, for DCI according to embodiments of the present disclosure. For example, encoding process 700 may be implemented by a BS 102 while decoding process 750 may be implemented by any of the UEs 111-116 of FIG. 1. This example is for illustration only and other embodiments can be used without departing from the scope of the present disclosure.

A gNB (e.g., the BS 102) separately encodes and transmits each DCI format in a respective PDCCH. When applicable, a RNTI for a UE that a DCI format is intended for masks a CRC of the DCI format codeword in order to enable the UE to identify the DCI format. For example, the CRC can include 24 bits and the RNTI can include 16 bits or 24 bits. The CRC of (non-coded) DCI format bits 702 is determined using a CRC computation unit 704, and the CRC is masked using an exclusive OR (XOR) operation unit 706 between CRC bits and RNTI bits 708. The XOR operation is defined as XOR(0,0)=0, XOR(0,1)=1, XOR(1,0)=1, XOR(1,1)=0. The masked CRC bits are appended to DCI format information bits using a CRC append unit 710. An encoder 712 performs channel coding, such as polar coding, followed by rate matching to allocated resources by rate matcher 714. Interleaving and modulation units 716 apply interleaving and modulation, such as QPSK, and the output control signal 718 is transmitted.

A received control signal 752 is demodulated and de-interleaved by a demodulator and a de-interleaver 754. A rate matching applied at a gNB transmitter is restored by rate matcher 756, and resulting bits are decoded by decoder 758. After decoding, a CRC extractor 760 extracts CRC bits and provides DCI format information bits 762. The DCI format information bits are de-masked 764 by an XOR operation with a RNTI 766 (when applicable) and a CRC check is performed by unit 768. When the CRC check succeeds (check-sum is zero), the DCI format information bits are regarded to be valid. When the CRC check does not succeed, the DCI format information bits are regarded to be invalid.

For each DL bandwidth part (BWP) indicated to a UE (e.g., the UE 116) in a serving cell, the UE (e.g., the UE 116) can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, CCE-to-resource element groups (REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 [REF2] v17.4.0, or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ)mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in TS 38.213 [REF3] v17.4.0.

A UE can be configured for operation with carrier aggregation (CA) for PDSCH receptions over multiple serving cells (DL CA) or for PUSCH transmissions over multiple serving cells (UL CA). The UE can also be configured multiple transmission-reception points (TRPs) per serving cell via indication (or absence of indication) of a coresetPoolIndex for CORESETs where the UE receives PDCCH scheduling a PDSCH from a corresponding TRP as described in TS 38.213 [REF3] v17.2.0 and TS 38.214 [REF4] v17.2.0. Network energy savings is becoming a performance indicator of greater importance for networks as the energy cost represents a substantial portion of the overall operating cost while an increasing demand for applications with higher data rates requires the use of more antennas and higher frequency bands which in turn requires a higher energy consumption and has larger environmental impact. To reduce energy consumption, a network should be able to adapt operation according to traffic conditions and operate in different network energy saving (NES) modes or network (NW) operation states.

In one example, in absence of UL/DL traffic, a network can reduce operation in time/frequency/spatial/power domains to a minimal one necessary for UEs to maintain an RRC connection to a serving gNB while in presence of UL/DL traffic, the NW can change an operation state to one corresponding to the traffic characteristics. Thus, the network (e.g., the network 130) can operate in various operating states, for example according to evaluations for NW energy savings and for servicing required traffic. In another example the network can use a number of operation states, and different operation states, or simply different states, for the network can be associated to transmission of specific signaling or to monitoring/reception of specific signaling by a serving gNB or by a UE, or can be associated to specific characteristics of transmissions and/or receptions, such as a periodicity or a transmit power.

For example, a first operation state can correspond to use of all/most resources in one or more of time/frequency/spatial/power domains by a serving gNB, a second operation state can correspond to minimal or no use of any such resources, while intermediate states can correspond to reduced utilization of most such resources such as for example, support of transmissions or receptions of only a subset of signals/channels or support of transmissions/receptions only in non-consecutive time intervals, or only from a subset of antenna elements or antenna ports, or only in a bandwidth that is smaller than a maximum bandwidth.

Present networks have limited capability to adapt an operation state in one or more of time/frequency/spatial/power domains. For example, in NR, there are transmissions or receptions by a serving gNB that are expected by UEs, such as transmissions of synchronization signal/physical broadcast channel (SS/PBCH) blocks, or of system information or of CSI-RS indicated by higher layers, or receptions of physical random access channel (PRACH) or sounding reference signal (SRS) indicated by higher layers. Reconfiguration of an operation state involves higher layer signaling by a SIB or by UE-specific RRC. That is a slow process and requires substantial signaling overhead, particularly for UE-specific RRC signaling. For example, it is currently not practical for a network in typical deployments to enter an energy saving state where the network does not transmit or receive due to low traffic as, in order to obtain material energy savings, the network needs to suspend transmissions or receptions for several tens of milliseconds and preferably for even longer time periods. A similar inability exists for suspending transmission or receptions for shorter time periods as a serving gNB may need to transmit SS/PBCH blocks every 5 msec and, in time division duplexing (TDD) systems with UL-DL configurations having few UL symbols in a period, the serving gNB may need to receive PRACH or SRS in most UL symbols in a period.

A capability of a serving gNB to improve service by fast adaptation of an operation state to the traffic types and loads, or to save energy by switching to a state that requires less energy consumption when an impact on service quality would be limited or none, would require the introduction of new procedures for the serving gNB to perform fast adaptation of the operation state, with small signaling overhead, while simultaneously informing UEs.

The general principle for adaptation of operation states by physical layer signaling includes a serving gNB indicating to a UE a set of operation states by higher layer signaling, such as by a SIB or UE-specific RRC signaling, and transmitting a PDCCH that provides a DCI format, referred to as DCI format 2_9 in the disclosure, indicating one or more indexes to the set of operation states for the UE to determine an update of operation states.

For example, in power domain, a first operation state can be associated with a first value of parameter ss-PBCH-BlockPower providing an average energy per resource element (EPRE) with secondary synchronization signals (SSS) in dBm, and a second operation state can be associated with a second value of a parameter ss-PBCH-BlockPower. For example, first and second operation states can be respectively associated with first and second values of parameter powerControlOffsetSS that provides a power offset (in dB) of non-zero power (NZP) CSI-RS RE to SSS RE.

For example, in frequency domain, first and second operation states can be respectively associated with first and second values of a parameter locationAndBandwidth that indicates a frequency domain location and a bandwidth for receptions or transmissions by UEs.

For example, in spatial domain, first and second operation states can be respectively associated with first and second values of a parameter maxMIMO-Layers that indicates a maximum number of MIMO layers to be used for PDSCH receptions by a UE in the associated active DL BWP, or with first and second values of a parameter nrOfAntennaPorts that indicates a number of antenna ports to be used for codebook determination for PDSCH receptions, or with first and second values of a parameter activeCoresetPoolIndex that coresetPoolIndex values for PDCCH transmissions in corresponding CORESETs and UEs can skip PDCCH receptions in a CORESET with coresetPoolIndex value that is not indicated by activeCoresetPoolIndex.

For example, in time domain, first and second operation states can be respectively associated with first and second values of a parameter ssb-PeriodicityServingCell that indicates a transmission periodicity, for example in milliseconds, for SS/PBCH blocks, or with first and second values of a parameter ssb-PositionsInBurst that indicates time domain positions of SS/PBCH blocks in a SS/PBCH block transmission burst, or with first and second values of a parameter groupPresence that indicates groups of SS/PBCH blocks, such as groups of four SS/PBCH blocks with consecutive indexes, that are transmitted.

When a UE is configured for operation on multiple serving cells, a gNB can configure each serving cell with a corresponding set of operation states that is the same for some or all of the multiple serving cells, or the serving cells are configured with different sets of operation states. A first serving cell can operate with a first set of operation states and a second serving cell can operate with a second set of operation states that includes one or more of the operation states of the first set. For example, the first serving cell and the second serving cell can both operate in a sleep state, which is a state without using time/frequency/spatial/power resources, the first serving cell can operate in operation states that adapt network functionalities in space domain and the second serving cell can operate in operation states that adapt network functionalities in frequency domain.

A gNB can indicate operation states through a bitmap wherein each bit of the bit-map corresponds to an operation state, and a UE can determine an initial operation state based on the indication by a corresponding bit in the bitmap. When the UE is configured for operation on multiple serving cells, the bitmap can be provided separately for each serving cell, or a same bitmap indicates operation states of a subset of serving cells, wherein subsets of serving cells can also be indicated by the gNB. For example, for 2 serving cells and 4 operation states per serving cell, the bitmap includes 8 bits, wherein the first 4 bits indicate one of the 4 operation states for a first serving cell and the second 4 bits indicate one of the 4 operation states for a second serving cell. Alternatively, the gNB can indicate operation states by enumerating values of a field such as, for example, a field of 2 bits with values of ‘00’, ‘01’, ‘10’, and ‘11’ mapping to a first, second, third, and fourth operating states. For example, for 2 serving cells and 4 operation states per serving cell, a first field of 2 bits can indicate one of the 4 operation states for a first serving cell and a second field of 2 bits indicate one of the 4 operation states for a second serving cell.

A gNB can transition from a current operation state to a new operation state on a serving cell, and indicate the new operation state to the UE in a DCI format, for example DCI format 2_9, using a 1-bit signaling to indicate one operation state among two configured operation states on one serving cell, or using a 2-bit signaling, in case of a field enumerating operation states, to indicate one operation state among four configured operation states on one serving cell. The gNB may transmit a PDCCH providing the DCI format 2_9 to indicate the operation state on a serving cell even if the operation state has not changed. For example, the gNB may transmit a PDCCH providing the DCI format 2_9 to indicate the operation states on each of the serving cells when the operation state changes in one of the serving cells.

A UE configured for operation on multiple serving cells can request a transition from one operating state to another operating state on one or more serving cells. For example, when a gNB operates in a state where the gNB does not receive in any of the serving cells and the UE needs to transmit data using multiple serving cells, the UE can request, via a state transition request (STR) information, the gNB to transition to subsets of serving cells to respective one or more operating states where the UE can be scheduled PUSCH transmissions. Similarly, when a gNB operates on a first serving cell in a state where the gNB does not receive and the UE has a need to transmit data using the first serving cell, the UE can provide STR information to the gNB requesting the gNB to transition to an operating state on the first serving cell that supports receptions from the UE. In one example the UE is configured for operation on a first serving cell and on a second serving cell, the UE transmits PUSCH on the second serving cells, and the UE can achieve higher data rates on the first serving cell due to deteriorating channel conditions on the second serving cell. The criterion for the UE to request switching transmissions from the second serving cell to the first serving cell can be indicated to the UE and/or specified in the system operation, such as for example to use a reference signal received power (RSRP) measurement with an indicated threshold for the difference of RSRP measurements on the first and second serving cells providing a trigger for STR when it is exceeded. In another example, the UE is able to transmit simultaneously on the first and second serving cells and requests the gNB to transition to an operating state on the first serving cell for the UE to be scheduled PUSCH transmissions on both serving cells. If a signal/channel transmission providing STR information by a UE is only supported when a serving gNB operates in a sleep state in each of the serving cells, that is a state without using time/frequency/spatial/power resources, the STR may also be referred to as a UE-initiated wake-up-signal (WUS) for the gNB, or a WUS for the serving cell if the gNB operates in the sleep state for the serving cell and the STR indicates an operation state other than the sleep state for the serving cell. In such cases, the STR may also be provided, for example, through a PRACH.

For operation with multiple serving cells, multiple signals or channels that provide STR that indicate an operation state transition in corresponding multiple serving cells can be received by a gNB at different times. To improve network energy savings, it can be beneficial to align a transmission of a channel such as a PUCCH or a PRACH, or of a signal, providing STR among UEs in different serving cells. Such alignment can enable a serving gNB to operate in a low energy state for a longer time period in each of the multiple serving cells, or to consume less energy for monitoring STR receptions in any of the operation states as the serving gNB does not need to receive channels or signals from UEs in any of the serving cells at different times. Alternatively, alignment of transmissions providing STR can be done among UEs of a same serving cell, and transmissions providing STR from UEs associated with a first serving cell can occur over a first time interval while transmissions providing STR from UEs associated with a second serving cell can occur over a second time interval, wherein first and second time intervals may not overlap or partially overlap based on a configuration provided in a SIB or by a serving cell-specific higher layer signaling.

To improve network energy savings, it can be beneficial to align a first operation state transition in a first serving cell in response to a transmission of a first channel/signal providing first STR information in the first serving cell and a second operation state transition in a second serving cell in response to a transmission of a second channel/signal providing STR information in the second serving cell. Such alignment allows a gNB to optimize transitions of operation states among each of the serving cells and maximize the network energy saving, but it may not minimize a time between transmissions of channels/signals providing STR and transmissions of PDCCHs providing a DCI format that indicates an operation state or schedules a PDSCH that indicates an operation state. In one example, an operation state transition in the first serving cell and an operation state transition in the second serving cell can occur during a same indicated time interval, which can be additionally associated with a periodicity configured by higher layers. UEs in the first and second serving cells are configured to monitor PDCCH receptions for detection of a DCI format that indicates operation states or schedules a PDSCH reception that indicates operation states. The indication can be an operation state, or a transition or no transition from a current operation state to another operation state. For example, the indication can be a 1-bit signaling, with value “0” indicating that the operation state has not changed, and value “1” indicating that the operation state has changed. In another example, an operation state transition in the first serving cell and an operation state transition in the second serving cell can occur during a first and a second indicated time interval, wherein the first time interval does not overlap with the second time interval, and first and second time interval can be adjacent/consecutive.

Therefore, embodiments of the present disclosure recognize that there is a need to identify operation states on multiple serving cells based on an indication by the gNB.

There is another need to provide STR information that enables a serving gNB to determine an operation state for a transition, including to maintain a current operation state, in multiple serving cells.

There is yet another need to determine resources and transmission occasions for a channel providing STR for multiple serving cells.

Present networks have limited capability to adapt an operation state in one or more of time/frequency/spatial/power domains. For example, in NR, there are transmissions or receptions by a serving gNB that are expected by UEs, such as transmissions of SS/PBCH blocks, or of system information or of CSI-RS indicated by higher layers, or receptions of PRACH or SRS indicated by higher layers. Reconfiguration of an operation state involves higher layer signaling by a SIB or by UE-specific RRC. That is a slow process and requires substantial signaling overhead, particularly for UE-specific RRC signaling. For example, it is currently not practical for a network in typical deployments to enter an energy saving state where the network (e.g., the network 130) does not transmit or receive due to low traffic as, in order to obtain material energy savings, the network needs to suspend transmissions or receptions for several tens of milliseconds and preferably for even longer time periods. A similar inability exists for suspending transmission or receptions for shorter time periods as a serving gNB may need to transmit SS/PBCH blocks every 5 msec and, in TDD systems with UL-DL configurations having few UL symbols in a period, the serving gNB may need to receive PRACH or SRS in most UL symbols in a period.

A capability of a serving gNB (e.g., the BS 102) to improve service by fast adaptation of an operation state to the traffic types and loads, or to save energy by switching to a state that requires less energy consumption when an impact on service quality would be limited or none, would require the introduction of new procedures for the serving gNB to perform fast adaptation of the operation state, with small signaling overhead, while simultaneously informing each of the UEs.

The general principle for adaptation of operation states by physical layer signaling includes a serving gNB indicating to a UE a set of operation states by higher layer signaling, such as by a SIB or UE-specific RRC signaling, and transmitting a PDCCH that provides a DCI format, referred to as DCI format 2_9 in the disclosure, indicating one or more indexes to the set of operation states for the UE to determine an update of operation states.

For example, in power domain, a first operation state can be associated with a first value of parameter ss-PBCH-BlockPower providing an average energy per resource element (EPRE) with secondary synchronization signals (SSS) in dBm, and a second operation state can be associated with a second value of a parameter ss-PBCH-BlockPower. For example, first and second operation states can be respectively associated with first and second values of parameter powerControlOffsetSS that provides a power offset (in dB) of non-zero power (NZP) CSI-RS RE to SSS RE.

For example, in frequency domain, first and second operation states can be respectively associated with first and second values of a parameter locationAndBandwidth that indicates a frequency domain location and a bandwidth for receptions or transmissions by UEs.

For example, in spatial domain, first and second operation states can be respectively associated with first and second values of a parameter maxMIMO-Layers that indicates a maximum number of MIMO layers to be used for PDSCH receptions by a UE (e.g., the UE 116) in the associated active DL BWP, or with first and second values of a parameter nrOfAntennaPorts that indicates a number of antenna ports to be used for codebook determination for PDSCH receptions, or with first and second values of a parameter activeCoresetPoolIndex that coresetPoolIndex values for PDCCH transmissions in corresponding CORESETs and UEs can skip PDCCH receptions in a CORESET with coresetPoolIndex value that is not indicated by active CoresetPoolIndex.

For example, in time domain, first and second operation states can be respectively associated with first and second values of a parameter ssb-PeriodicityServingCell that indicates a transmission periodicity, for example in milliseconds, for SS/PBCH blocks, or with first and second values of a parameter ssb-PositionsInBurst that indicates time domain positions of SS/PBCH blocks in a SS/PBCH block transmission burst, or with first and second values of a parameter groupPresence that indicates groups of SS/PBCH blocks, such as groups of four SS/PBCH blocks with consecutive indexes, that are transmitted.

When a UE is configured for operation on multiple serving cells, a gNB can configure each serving cell with a corresponding set of operation states that is the same for some or all of the multiple serving cells, or each of the serving cells are configured with different sets of operation states. A first serving cell can operate with a first set of operation states and a second serving cell can operate with a second set of operation states that includes one or more of the operation states of the first set. For example, the first serving cell and the second serving cell can both operate in a sleep state, which is a state without using time/frequency/spatial/power resources, the first serving cell can operate in operation states that adapt network functionalities in space domain and the second serving cell can operate in operation states that adapt network functionalities in frequency domain.

A gNB can indicate operation states through a bitmap wherein each bit of the bit-map corresponds to an operation state. A UE can determine an initial operation state based on the indication by a corresponding bit in the bitmap. When the UE is configured for operation on multiple serving cells, the bitmap can be provided separately for each serving cell, or a same bitmap indicates operation states of a subset of serving cells, wherein subsets of serving cells can also be indicated by the gNB. For example, for 2 serving cells and 4 operation states per serving cell, the bitmap includes 8 bits, wherein the first 4 bits indicate one of the 4 operation states for a first serving cell and the second 4 bits indicate one of the 4 operation states for a second serving cell. Alternatively, the gNB can indicate operation states by enumerating values of a field such as, for example, a field of 2 bits with values of ‘00’, ‘01’, ‘10’, and ‘11’ mapping to a first, second, third, and fourth operating states. For example, for 2 serving cells and 4 operation states per serving cell, a first field of 2 bits can indicate one of the 4 operation states for a first serving cell and a second field of 2 bits indicate one of the 4 operation states for a second serving cell.

A gNB can transition from a current operation state to a new operation state on a serving cell, and indicate the new operation state to the UE in a DCI format, for example DCI format 2_9, using a 1-bit signaling to indicate one operation state among two configured operation states on one serving cell, or using a 2-bit signaling, in case of a field enumerating operation states, to indicate one operation state among four configured operation states on one serving cell. The gNB may transmit a PDCCH providing the DCI format 2_9 to indicate the operation state on a serving cell even if the operation state has not changed. For example, the gNB may transmit a PDCCH providing the DCI format 2_9 to indicate the operation states on each of the serving cells when the operation state changes in one of the serving cells.

When a UE is configured for operation on multiple serving cells, at any given time a first operation state for a first serving cell may be same or different than a second operation state for a second serving cell. Also, a change from a first operation state to a second operation state in one serving cell may occur independently of a change in another serving cell. For example, a first serving cell of the multiple serving cells operates with a same operation state for a time period during which a second serving cell changes its operation state. A change of operation state on a serving cell may occur at time instances, or with an additional application delay after the time instances, associated with a reception of a PDCCH that provides a DCI format indicating an operation state that is different than the current state. Such time instances can be associated with a configuration provided by a SIB or a UE-specific higher layer signaling, and can be associated with search space sets used for the PDCCH receptions.

When a UE is configured for operation on multiple serving cells, the UE monitors a set of PDCCH candidates on the active DL BWP on each activated serving cell configured with PDCCH monitoring (scheduling cell) according to corresponding search space sets where monitoring implies receiving each PDCCH candidate and decoding according to each DCI format associated with the search space set of the PDCCH candidate, for example DCI format 2_9, that indicates operation states. In an activated scheduling cell, the search space sets for DCI format 2_9 can be separate from other search space sets for other DCI formats that the serving gNB provides to the UE or some or all search space sets can be common and the UE can monitor PDCCH for the detection of both the DCI format 2_9 that indicates operation states and for the detection of other DCI formats providing other information, for example as described in TS 38.212 [REF2] v17.6.0. The search space sets can be CSS sets or USS sets. When the search space sets are CSS sets, a serving gNB can indicate the search space sets associated with DCI format 2_9 through higher layer signaling in a SIB or through UE-specific RRC signaling. A UE can monitor PDCCH for detection of DCI format 2_9 both in the RRC_CONNECTED state and in the RRC_INACTIVE state according to the corresponding search space sets and discontinuous reception (DRX) operation may not apply for PDCCH receptions that provide DCI format 2_9. Alternatively, to receiving PDCCHs that provide DCI format 2_9 in the active DL BWP of the activated serving cell, the UE can receive PDCCHs providing DCI format 2_9 in a DL BWP that is shared by UEs of the multiple serving cells to receive PDCCHs for detection of DCI format 2_9 that indicates operation states, and for other DCI formats providing information for network operation.

A UE configured for operation on multiple serving cells receives an indication of an operation state on each serving cell separately. For operation with two serving cells, the UE receives PDCCH, on a first serving cell, providing a first DCI format 2_9 that indicates a first operation state for the first serving cell and receives PDCCH, on a second serving cell, providing a second DCI format 2_9 that indicates a second operation state for the second serving cell, wherein the first operation state and the second operation state, separately indicated, can be the same state or different states. A first field of the first DCI format 2_9 used for the indication of the first operation state for the first serving cell and a second field of the second DCI format 2_9 used for the indication of the second operation state for the second serving cell can have different sizes when the number of operation states configured for the first serving cell is different from the number of operation states configured for the second serving cell, or can have a same size as the maximum size among first and second fields. For example, if the gNB configures N₁=2 operation states for the first serving cell and N₂=4 operation states for the second serving cell, the size of the field in the DCI format that indicates the operation state would be 1 bit in the first serving cell and 2 bits in the second serving cell, or both sizes can be 2 bits.

A UE configured for operation on multiple serving cells receives an indication of an operation state on one serving cell and the indication applies to a subset of serving cells. In this example, each of the serving cells of the subset of serving cells transition to a same state. For example, for a subset of two serving cells configured to have a same operation state, the UE receives, on a first serving cell, a PDCCH providing DCI format 2_9 that indicates a single operation state that is same for a first serving cell and a second serving cell.

A UE configured for operation on multiple serving cells receives multiple indications of operation states in a DCI format 2_9. For example, for operation with two serving cells, the UE receives, on a first serving cell, a DCI format 2_9 that indicates a first operation state for the first serving cell and a second operation state for the second serving cell. The UE can distinguish a DCI format 2_9 from other DCI formats based on a unique RNTI used to scramble the CRC of DCI format 2_9.

A UE configured for operation on multiple serving cells can request a transition from one operating state to another operating state on one or more serving cells. For example, when a gNB operates in a state where the gNB does not receive in any of the serving cells and the UE needs to transmit data using multiple serving cells, the UE can request, via a STR information, the gNB to transition to subsets of serving cells to respective one or more operating states where the UE can be scheduled PUSCH transmissions. Similarly, when a gNB operates on a first serving cell in a state where the gNB does not receive and the UE has a need to transmit data using the first serving cell, the UE can provide STR information to the gNB requesting the gNB to transition to an operating state on the first serving cell that supports receptions from the UE. In one example the UE is configured for operation on a first serving cell and on a second serving cell, the UE transmits PUSCH on the second serving cells and the UE can achieve higher data rates on the first serving cell due to deteriorating channel conditions on the second serving cell. The criterion for the UE to request switching transmissions from the second serving cell to the first serving cell can be indicated to the UE and/or specified in the system operation, such as for example to use an RSRP measurement with an indicated threshold for the difference of RSRP measurements on the first and second serving cells providing a trigger for STR when it exceeds the indicated threshold. In another example, the UE is able to transmit simultaneously on the first and second serving cells and requests the gNB to transition to an operating state on the first serving cell for the UE to be scheduled PUSCH transmissions on both serving cells. If a signal/channel transmission providing STR information by a UE is only supported when a serving gNB operates in a sleep state in each of the serving cells, that is a state without using time/frequency/spatial/power resources, the STR may also be referred to as a UE-initiated wake-up-signal (WUS) for the gNB, or a WUS for the serving cell if the gNB operates in the sleep state for the serving cell and the STR indicates an operation state other than the sleep state for the serving cell. In such cases, the STR may also be provided, for example, through a PRACH.

For operation with multiple serving cells, multiple signals or channels that provide STR that indicate an operation state transition in corresponding multiple serving cells can be received by a gNB at different times. To improve network energy savings, it can be beneficial to align a transmission of a channel such as a PUCCH or a PRACH, or of a signal, providing STR among UEs in different serving cells. Such alignment can enable a serving gNB to operate in a low energy state for a longer time period in each of the multiple serving cells, or to consume less energy for monitoring STR receptions in any of the operation states as the serving gNB does not need to receive channels or signals from UEs in any of the serving cells at different times. Alternatively, alignment of transmissions providing STR can be done among UEs of a same serving cell, and transmissions providing STR from UEs associated with a first serving cell can occur over a first time interval while transmissions providing STR from UEs associated with a second serving cell can occur over a second time interval, wherein first and second time intervals may not overlap or partially overlap based on a configuration provided in a SIB or by a serving cell-specific higher layer signaling.

To improve network energy savings, it can be beneficial to align a first operation state transition in a first serving cell in response to a transmission of a first channel/signal providing first STR information in the first serving cell and a second operation state transition in a second serving cell in response to a transmission of a second channel/signal providing STR information in the second serving cell. Such alignment allows a gNB to optimize transitions of operation states among serving cells and maximize the network energy saving, but it may not minimize a time between transmissions of channels/signals providing STR and transmissions of PDCCHs providing a DCI format that indicates an operation state or schedules a PDSCH that indicates an operation state. In one example, an operation state transition in the first serving cell and an operation state transition in the second serving cell can occur during a same indicated time interval, which can be additionally associated with a periodicity configured by higher layers. UEs in the first and second serving cells are configured to monitor PDCCH receptions for detection of a DCI format that indicates operation states or schedules a PDSCH reception that indicates operation states. In another example, an operation state transition in the first serving cell and an operation state transition in the second serving cell can occur during a first and a second indicated time interval, wherein the first time interval does not overlap with the second time interval, and first and second time interval can be adjacent/consecutive.

Embodiments of the present disclosure recognize that there is a need to provide STR information that enables a serving gNB to determine an operation state for a transition, including to maintain a current operation state, in multiple serving cells.

There is another need to determine resources and transmission occasions for a channel providing STR for multiple serving cells.

The following embodiments provide that a UE provides STR information to a serving gNB through a PUCCH transmission. The embodiments are also applicable in case the UE provides STR information to a serving gNB through a signal transmission, such as by using a sequence with specific parameters, for example as for SRS transmission.

Throughout this disclosure, descriptions for a first serving cell and a second serving cell also apply for operation with more than two serving cells, and for serving cells of the MCG (Master Serving Cell Group) or of the SCG (Secondary Serving Cell Group).

Throughout this disclosure, descriptions for a UE configured for multiple serving cell operation also apply when the UE is configured for operation with two or more carriers such as a normal UL carrier (NUL) and a supplementary UL carrier (SUL).

Throughout the disclosure, a NES mode or an operation state on a serving cell is also referred as an operation state. The terms “NES mode”, “operation state”, or “operation state” are used interchangeably in this disclosure to refer to a network operation that can be dynamically adapted to save energy based on traffic types and load, so that the network (e.g., the network 130) may operate in more than one state.

A UE can be provided by a serving gNB a set of operation states where each of the operation states corresponds to a configuration for transmissions and receptions by the serving gNB in one or more of time/frequency/spatial/power domains. For operation with multiple serving cells, the gNB can configure a same set of operation states for each of the serving cells, or can configure different sets of operation states for at least some of the serving cells. For example, the serving gNB configures a first set of operation states for a first set of cells and a second set of operation states for a second set of cells, first and second sets of operation states can be same or different, and first and second set of cells can include one or more cells. The serving gNB can provide the set of operation states via higher layer signaling, such as in a system information block (SIB) or by UE-specific RRC signaling, for the serving cells. Subsets of serving cells can be configured to have a same operation state and, in such cases, an indication of an operation state is provided for the subset of serving cells instead of each serving cell in the subset of serving cells. In one example, the UE is configured for operation with a first serving cell and a second serving cell, and is provided with a same set of operation states for both serving cells. In another example, the UE is provided a first set of operation states for the first serving cell and a second set of operation states for the second serving cell, wherein the first set includes at least one operation state that is also included in the second set of operation states. In yet another example, the UE is provided with a first set of operation states and a second set of operation states, and first and second sets include different operation states and the number of operation states in the first set can be same or different than the number of operation states of the second set of operation states.

In a first approach, a UE (e.g., the UE 116) configured for operation with multiple serving cells can provide STR information through resource selection for a corresponding PUCCH transmission in a corresponding serving cell such as a primary cell (PCell). For N operation states across serving cells, in order for the UE to provide log₂(N) bits of STR information, the UE needs to be provided N PUCCH resources to select from for the PUCCH transmission. Those resources can be common among UEs and be provided by a SIB or by UE-specific RRC signaling (and it is then up to the gNB (e.g., the BS 102) whether or not they are shared among UEs). For example, for 2 cells with 4 operation states per serving cell, wherein an operation state on a first cell can be independent of an operation state on a second cell, there is a total of N=4×4=16 combinations of operation states and a combination can be indicated via a selection of a PUCCH resource from N=16 PUCCH resources for a PUCCH transmission. If an operation state for a first serving cell is linked to an operation state for a second serving cell, there are 4 combinations and can be indicated via a selection of a PUCCH resource from 4 PUCCH resources. For example, for a pair of serving cells (or a pair of subsets of cells), the UE can be configured to indicate one pair of operation states (A, E), (B, F), (C, G) and (D, H), wherein the set of operation states {A, B, C, D} for the first serving cell (or for the first subset of cells) may or may not have common elements with the set of operation states {E, F, G, H} for the second serving cell (or for the second subset of cells). In case of a subset of cells, the subset can include cells that are not serving cells for the UE and an indication is then only for the serving cells from the subset of cells.

In one example, for N combinations of operation states across serving cells, including the case of N operation states for a single serving cell, or across subsets of cells with same operation state for cells in a subset of cells, the UE can be provided N PUCCH resources, and the UE selects resources from the N PUCCH resources for a PUCCH transmission that provides STR information indicating a combination of operation states. Those resources can be common among UEs and serving cells can be provided separate indexes for the purpose of indicating an operation state, wherein the indexes can be common among UEs and different from the UE-specific indexes of serving cells for other functionalities such as for operation with carrier aggregation. The UE selects a PUCCH resource for the PUCCH transmission with STR information and transmits the PUCCH on a serving cell such as the PCell.

In one example, for N combinations of operation states across serving cells, as previously described, the UE can be provided N PUCCH resources to select from for a PUCCH transmission with STR information, wherein PUCCH resources from the provided PUCCH resources, as defined in TS 38.213 [REF3] v17.6.0, Table 9.2.1-1, are associated with PUCCH transmissions on a serving cell over a time period. A separate information element in a SIB can indicate PUCCH resources in a similar manner as indicating PUCCH resources to UEs without UE-dedicated PUCCH resources as described in TS 38.213 [REF3] v17.6.0.

In a second approach, a UE configured for operation with multiple serving cells can provide STR information through a PUCCH transmission on a serving cell such as the PCell wherein the PUCCH transmission includes information bits. If the number of information bits is not larger than 2, a serving gNB can provide to the UE a PUCCH resource, associated for example with PUCCH format 1, for the UE to use for a PUCCH transmission providing STR information. If the number of information bits is larger than 2, the serving gNB can provide to the UE a PUCCH resource, associated for example with PUCCH format 2, 3, or 4, for the UE to use for a PUCCH transmission providing STR information.

In a third approach, a UE configured for operation with multiple serving cells can provide STR information for a set of serving cells through a PUCCH transmission, wherein the PUCCH transmission includes information bits and the set of serving cells includes at least one serving cell from the multiple serving cells. Based on the number of information bits required to provide STR information for N operation states and on the number of serving cells, a serving gNB can provide to the UE PUCCH resources associated with a PUCCH format for the UE to use for a PUCCH transmission providing STR information for the set of serving cells. Each serving cell or each subset of serving cells, of the multiple serving cells is associated with a serving cell index or with a subset index. The PUCCH transmission includes information bits wherein each bit (or group of bits) from most significant bit (MSB) to least significant bit (LSB) corresponds to a serving cell, or to a subset of serving cells, in ascending order of serving cell index or of the index for the subset of serving cells. For periodic or aperiodic STR reporting triggered by a MAC CE or a DCI format, the UE may provide STR information for each of the serving cells of the set of serving cells, or for only the activated serving cells, or for a subset of serving cells associated with a triggering state of the MAC CE command or of a field in the DCI format. The UE can provide STR information for deactivated cells when the UE receives RS, such as SS/PBCH blocks or CSI-RS, for the UE to perform measurements and determine a preferred operation state. The reception of the RS can be with parameters, including time instances, that are indicated by a serving gNB for the corresponding deactivated cells, or subset of deactivated cells when a RS reception on one cell can determine an operation state for each of the deactivated serving cells in the subset of deactivated serving cells, such as for example for intra-band serving cells. If the UE does not provide STR information for a deactivated serving cell, information bits of the PUCCH transmission corresponding to the deactivated serving cell can be set to a predetermined value, such as “0” or to “1”. Alternatively, information bits for indication of operation states of deactivated cells are not included in the PUCCH transmission and bits corresponding to operation states of activated serving cells are reordered according to respective indexes of activated serving cells. Information for serving cell activation and STR reporting for deactivated serving cells can be provided by higher layer parameters.

In a fourth approach, a UE configured for operation with multiple serving cells can provide STR information through a PUSCH transmission, wherein the STR information can be multiplexed with or without data in the PUSCH based on whether or not a DCI format scheduling the PUSCH transmission indicates presence or absence of an uplink shared channel (UL-SCH) for data. In one example, the UE can receive DCI formats that schedule time-overlapping PUSCH transmissions on more than one serving cells. The UE multiplexes the STR information in the PUSCH transmission on the serving cell with the smaller index or in the PUSCH transmission with the larger RB allocation or the larger MCS wherein, for a same maximum RB allocation or MCS among multiple serving cells, the STR information can be multiplexed in the PUSCH transmission on the serving cell with the smaller index. The PUSCH transmission may be a configured grant Type 1 PUSCH transmission by higher layers or a configured grant Type 2 PUSCH transmission that is configured by higher layers and activated by a DCI format. The UE may provide STR information multiplexed with data of a configured grant PUSCH transmission based on a configuration for the multiplexing, or the UE multiplexes the STR information in a configured grant Type 2 PUSCH transmission based on an indication in the activation DCI format.

In a fifth approach, a UE configured for operation with multiple serving cells can provide STR information for one or more serving cells together with other uplink control information (UCI), such as a CSI report or a SR, in a PUCCH or a PUSCH transmission, thereby introducing STR information as a new UCI type.

FIG. 8 illustrates a flowchart of an example UE procedure 800 for transmitting uplink signals/channels indicating STR information on subsets of serving cells according to embodiments of the present disclosure. For example, procedure 800 for transmitting uplink signals/channels indicating STR information on subsets of serving cells can be performed by any of the UEs 111-116 of FIG. 1, such as the UE 111, and a complimentary procedure may be performed by a BS, such as the BS 102. This example is for illustration only and other embodiments can be used without departing from the scope of the present disclosure.

The procedure begins in 810, a UE is provided by a SIB uplink channel resources for transmissions with STR information for subsets of serving cells on corresponding subsets of serving cells. In 820, the UE determines resources for uplink channel transmissions on subsets of serving cells. In 830, the UE transmits the uplink channels using the determined resource on subsets of serving cell.

In a sixth approach, when a UE is configured for operation with multiple serving cells and a gNB configures a same number of operation states for each serving cell, the UE may transmit STR information in more than one serving cells. In one example, the UE transmits STR information corresponding to a first subset of serving cells in a first serving cell and transmits STR information corresponding to a second subset of serving cells in a second serving cell, wherein the first serving cell may or may not be one of the cells of the first subsets of serving cells and the second serving cell may or may not be one of the cells of the second subsets of serving cells. In one example, the UE transmits STR information for each serving cell of the multiple serving cells on the respective serving cell. The UE can provide STR information for more than one serving cells in respective more than one signal/channel transmissions using resources provided by the gNB for the more than one signal/channel transmissions. In one example, the gNB provides resources for multiple transmissions of an uplink channel, for example a dedicated uplink channel for STR information, that includes only the STR information on the multiple serving cells. The channel can be a dedicated channel for providing STR information. In one example, the gNB provides PUCCH resources for multiple PUCCH transmissions that include STR information on the multiple serving cells. In one example, the gNB provides PUCCH resources for multiple PUCCH transmissions that include STR and UCI information on the multiple serving cells. In one example, the gNB provides PUSCH resources for multiple PUSCH transmissions that include STR information, and may or may not include data, on the multiple serving cells. In one example, the gNB provides RS resources for multiple RS transmissions that include STR information on the multiple serving cells. Those resources provided by the gNB for the multiple uplink transmissions corresponding to the multiple STR information on the multiple serving cells can be assigned by the gNB for each of the multiple uplink transmissions or the UE selects resources from the provided resources for transmissions with STR in multiple serving cells. This allows more flexibility for resource allocation and better resource sharing when serving cells are switched on and off, or the number of serving cells is large The gNB may provide resources for the multiple uplink transmissions in different time interval to different uplink channels. For example, in a first time interval, the gNB provides resources for transmissions of a dedicated channel with STR on multiple cells, in a second time interval provides PUCCH resources for multiple PUCCH transmissions with STR, in a third time interval provides PUCCH resources for multiple PUCCH transmissions with STR and UCI, and so on. The UE may provide STR information through multiple transmissions of a dedicated channel for a first subset of serving cells and through multiple PUCCH transmissions for a second subset of serving cells.

With reference to FIG. 8, an example procedure for a UE to transmit uplink signals/channels indicating STR information on resources provided for STR information on subsets of serving cells is shown.

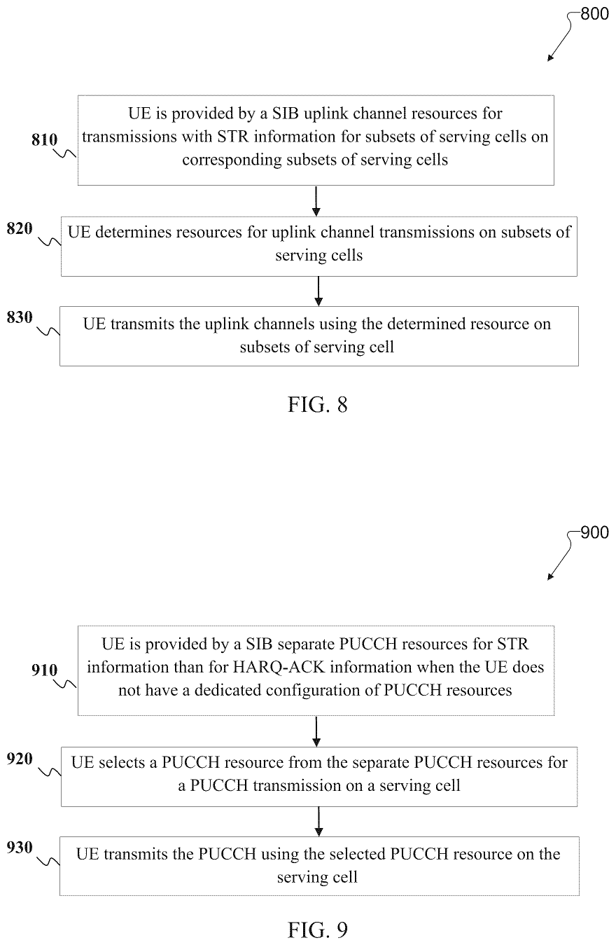

FIG. 9 illustrates a flowchart of an example UE procedure 900 for transmitting a PUCCH indicating STR information to a serving cell according to embodiments of the present disclosure. For example, procedure 900 for transmitting a PUCCH indicating STR information to a serving cell may be performed by any of the UEs 111-116 of FIG. 1, such as the UE 112, and a complimentary procedure may be performed by a BS, such as the BS 102. This example is for illustration only and other embodiments can be used without departing from the scope of the present disclosure.

The procedure begins in 910, a UE is provided by a SIB separate PUCCH resources for STR information than for hybrid automatic repeat request acknowledgement (HARQ-ACK) information when the UE does not have a dedicated configuration of PUCCH resources. In 920, the UE selects a PUCCH resource from the separate PUCCH resources for a PUCCH transmission with STR information on a serving cell, such as the primary cell. In 930, the UE transmits the PUCCH using the selected PUCCH resource on the serving cell.

With reference to FIG. 9, an example procedure for a UE to transmit a PUCCH indicating STR information on PUCCH resources provided for STR information on a serving cell is shown.

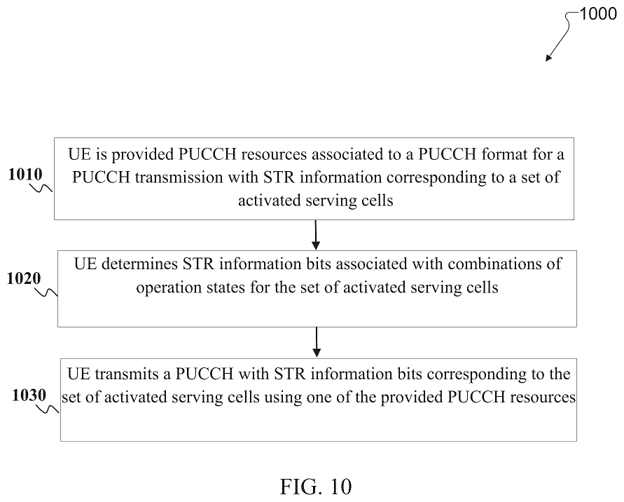

FIG. 10 illustrates a flowchart of an example UE procedure 1000 for transmitting a PUCCH indicating STR information to a set of activated serving cells according to embodiments of the present disclosure. For example, procedure 1000 for transmitting a PUCCH indicating STR information to a set of activated serving cells may be performed by any of the UEs 111-116 of FIG. 1, such as the UE 113. This example is for illustration only and other embodiments can be used without departing from the scope of the present disclosure.

The procedure begins in 1010, a UE is provided PUCCH resources for a PUCCH transmission with STR information corresponding to a set of activated serving cells. In 1020, the UE determines STR information bits to provide in a PUCCH transmission on a serving cell, wherein the STR information bits are associated with combinations of operation states for the set of activated serving cells. In 1030, the UE transmits the PUCCH with the STR information bits corresponding to the set of activated serving cells using one of the provided PUCCH resources.

With reference to FIG. 10, an example procedure for a UE to transmit a PUCCH indicating STR information for combinations of operation states for a set of activated serving cells is shown.

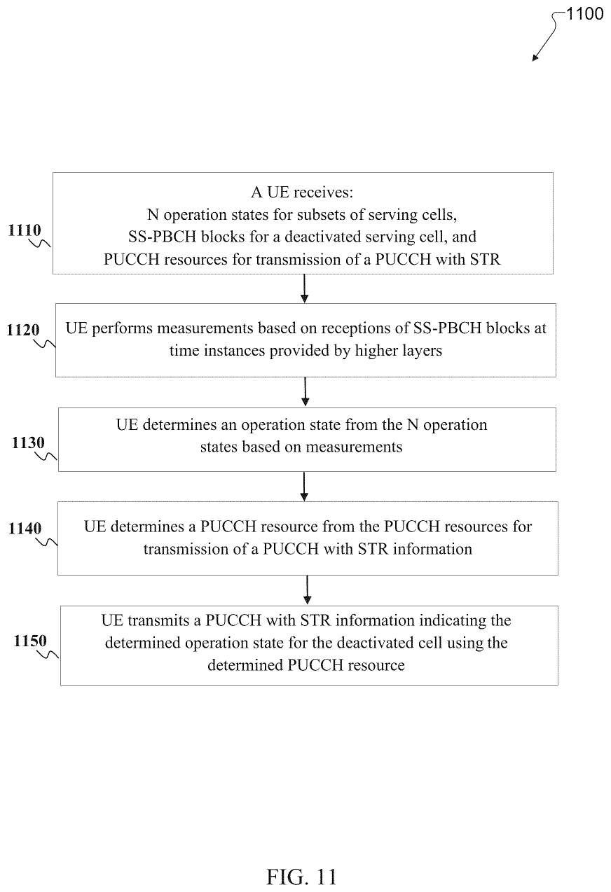

FIG. 11 illustrates a flowchart of an example UE procedure 1100 for transmitting a PUCCH indicating STR information to a deactivated cell according to embodiments of the present disclosure. For example, procedure 1100 for transmitting a PUCCH indicating STR information to a deactivated cell may be performed by any of the UEs 111-116 of FIG. 1, such as the UE 114. This example is for illustration only and other embodiments can be used without departing from the scope of the present disclosure.

The procedure begins in 1110, a UE receives information for: N operation states for subsets of serving cells, including the case that each subset contains a single serving cell, SS-PBCH blocks for a deactivated serving cell, and PUCCH resources for transmission of a PUCCH with STR information. In 1120, the UE performs measurements based on receptions of SS-PBCH blocks at time instances provided by higher layers, such as in a SIB or by UE-specific RRC. In 1130, the UE determines an operation state from the N operation states based on measurements. In 1140, the UE determines a PUCCH resource from the PUCCH resources for transmission of a PUCCH with STR information. In 1150, the UE transmits a PUCCH with STR information indicating the determined operation state for the deactivated cells using the determined PUCCH resource.

With reference to FIG. 11, an example procedure for a UE to transmit a PUCCH indicating STR information for a deactivated cell is shown.

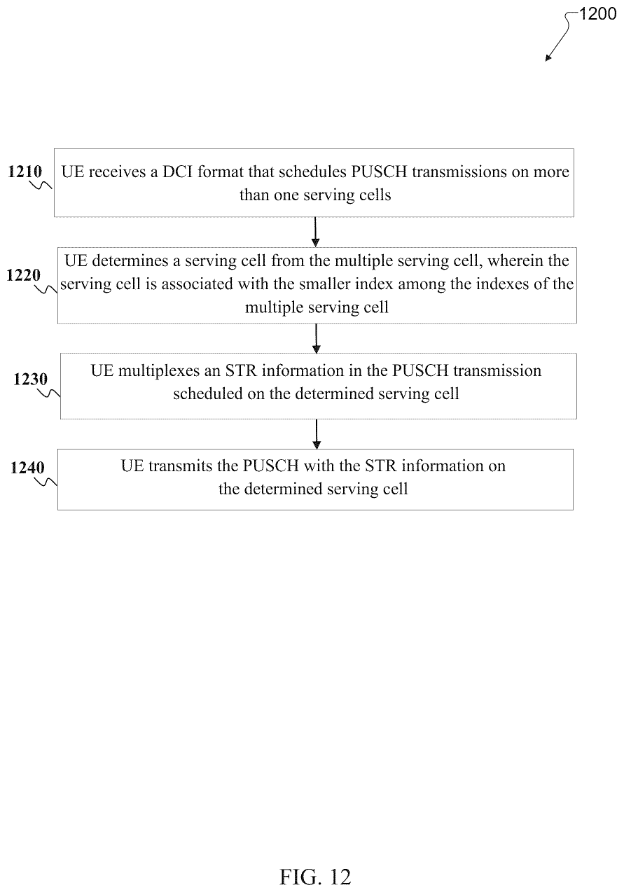

FIG. 12 illustrates a flowchart of an example UE procedure 1200 for transmitting a PUSCH indicating STR information according to embodiments of the present disclosure. For example, procedure 1200 for transmitting a PUSCH indicating STR information can be performed by any of the UEs 111-116 of FIG. 1, such as the UE 115, and a complimentary procedure may be performed by a BS, such as the BS 103. This example is for illustration only and other embodiments can be used without departing from the scope of the present disclosure.

The procedure begins in 1210, a UE receives DCI formats that schedule PUSCH transmissions on more than one serving cells. In 1220, the UE determines a serving cell from the more than one serving cell, wherein the serving cell is associated with the smaller index among the indexes of the more than one serving cells. In 1230, the UE multiplexes STR information in the PUSCH transmission on the serving cell with the smaller index. In 1240, the UE transmits the PUSCH with the STR information on the determined serving cell.

With reference to FIG. 12, an example procedure for a UE to transmit a PUSCH with STR information is shown.

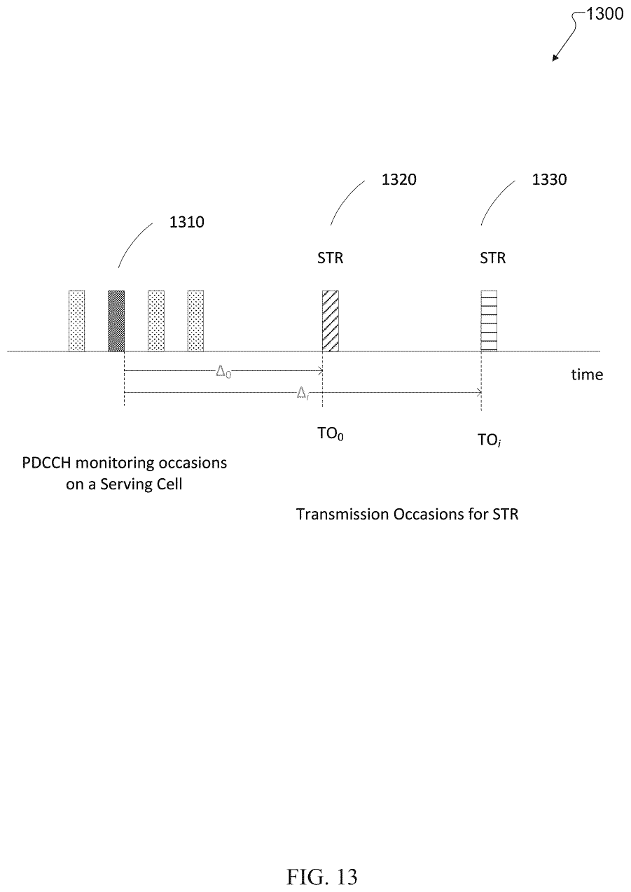

FIG. 13 illustrates a timeline 1300 of an example relationship for PUCCH transmissions and PDCCH monitoring occasions according to embodiments of the present disclosure. For example, timeline 1300 of an example relationship for PUCCH transmissions and PDCCH monitoring occasions can be followed by any of the UEs 111-116 of FIG. 1, such as the UE 116 of FIG. 3. This example is for illustration only and other embodiments can be used without departing from the scope of the present disclosure.

In one example, Δ₀ is a time offset between an end of a PDCCH reception providing a DCI format that indicates to the UE to report STR information 1310 and an earliest transmission occasion of a PUCCH or a PUSCH with the STR information 1320. For example, the DCI format is an activation DCI format, and the UE provides the STR information in a PUCCH transmission.

In another example, Δᵢ is a time offset between an end of a PDCCH reception providing a DCI format that indicates to the UE to provide STR information in a PUCCH or PUSCH 1310 and a transmission of the STR information in the PUCCH or the PUSCH in a first respective transmission occasion that is after the time offset 1320, 1330. For example, the DCI format is an activation DCI format, and the UE provides the STR information in a PUCCH.

For operation with multiple serving cells, a UE may transmit one or more signals/channels providing STR information for operation states on the multiple serving cells and transmission occasions (TOs) corresponding to the transmission of a channel/signal providing the STR information need to be defined.

When a UE is configured for operation with multiple serving cells and is provided information for combination of operation states for the multiple serving cells by a gNB, the UE can provide STR information for a combination of operation states for one or more subsets of serving cells to allow adaptation of operation states on the one or more serving cells by the gNB. The gNB may indicate to the UE enabled adaptation of an operation state for a first subset of serving cells in a first time interval and on a second subset of serving cells for a second time interval, for example, to facilitate reduced UE power consumption for measurements by the UE as such measurements can be limited to different subsets of serving cells in different time intervals. The UE may provide STR information for a subset of serving cells in both the first and second time intervals regardless of whether adaptation of the operation state is performed for the subset of serving cells during such time intervals or of whether each of the serving cells in the subset of serving cells are activated. A serving gNB (e.g., the BS 102) may indicate disabling of STR information from a UE, for example, when the serving gNB is in a sleep state associated with absence of transmissions or receptions. Thus, there is a need for the UE to receive an indication of the timing when to provide STR information. The indication can be provided by higher layer RRC parameters or MAC CE, or by a physical layer signaling, or by a combination of the above.

In a first approach, a UE (e.g., the UE 116) is configured with periodic STR reporting, for example in a PUCCH, and provides STR information based on time periods provided by a SIB or by UE-specific RRC signaling. A first time period over which the UE is expected to provide STR information and a second time period over which the UE is expected not to provide STR information for a serving cell can be same or different, or for a subset of serving cells, and be provided by higher layers. The gNB may configure only the first duration or only the second duration or both. The value of the first or second duration can be zero or larger than zero. For example, the gNB can configure a large value for the first duration for a first subset of serving cells where adaptation of operation state is prioritized and configure a value of zero for a second subset of serving cells where the gNB would not change a current operation state. Configurations of the first or second duration can be provided by a cell-specific higher layer signaling or by a UE-specific higher layer signaling and can be subject to a UE capability, for example, on a processing capability to perform measurements for a number of serving cells within a time period. Configured values for first duration and/or second duration can be maximum values, and can be also subject to a UE capability or configuration.

For operation with M subsets of cells, wherein a subset may or may not include serving cells, a gNB can configure M time periods and indicate to provide STR information for a subset of serving cells over a corresponding time period. For example, for operation with 4 subsets of cells, the gNB configures 4 time periods and STR information associated with a first subset of cells is provided during a first time period T₁, STR information associated with a second subset of cells is provided during a second time period T₂, and so on. Reporting of STR information for a subset of cells can have periodicity of P slots. Every P slots STR information can be reported over a time period that includes one or more TOs for the STR reporting.

In a second approach, a UE is configured with aperiodic STR reporting triggered by a MAC CE. A gNB uses a MAC CE to indicate to the UE to provide STR information for a first subset of cells that is prioritized for adaptation of operation states and, after reception of the MAC CE, the UE provides STR information over a configured or (pre-)determined time period and/or until the UE receives another MAC CE that indicates not to provide STR information for the first subset of cells and may provide STR information for a second subset of cells. For a PUCCH transmission providing STR information, a first TO can be defined by a minimum time offset relative to an end of a PDSCH reception providing the MAC CE. The minimum time offset can be provided by cell-specific or UE-specific higher layer signaling or be defined in the specifications of the system operation. The PUCCH transmission can be at an earliest time after the minimum time offset where the UE can transmit PUCCH. After the first TO, subsequent PUCCH transmissions are transmitted in TOs associated with a periodicity of P slots during the time period. Alternatively, STR reporting can be aperiodic and triggered by a field in a DCI format, wherein a value of the field maps to a subset of cells for STR information and the mapping can be provided to the UE by higher layers.

In a third approach, a UE is configured with semi-persistent STR reporting triggered by a MAC CE, or by a DCI format providing an activation command for STR reporting. The UE transmits a PUSCH with STR information, or a PUCCH with STR information, based on a configuration and/or on whether the STR is triggered by the MAC CE or by the DCI format.

In a fourth approach, periodic STR reporting is configured by RRC signaling and is enabled or disabled by a MAC CE. After reception of the MAC CE, the UE is not expected to provide STR information over an indicated or (pre-)determined time period and/or until the UE receives another MAC CE that indicates to provide STR information.

In a fifth approach, STR reporting is based on an indication at the physical layer. A gNB uses a DCI format to indicate to a UE to provide STR information. The DCI format can include a field indicating to the UE to provide STR information for one or more subsets of cells, wherein the subsets of cells are indicated to the UE by higher layers together with a mapping of the field values to the subsets of cells. For example, a 2-bit field in the DCI format can indicate to a UE whether to not provide STR information for any subset of cells, or whether to provide STR information for a first, second, or both first and second subsets of cells.

For a serving cell, a first TO for a PUCCH transmission with STR can be defined to be after a time offset relative to an end of a PDCCH reception providing the DCI format that includes the indication. The time offset can be provided by higher layers or be defined in the specifications of the system operation. After the first TO, subsequent PUCCH transmissions occur in PUCCH TOs associated with a periodicity of P slots during the time period.

With reference to FIG. 13, an example of a timing relationship for a PUCCH transmissions with STR information and PDCCH monitoring occasions for detection of a DCI format that triggers the reporting of STR information in the PUCCH transmission is shown.

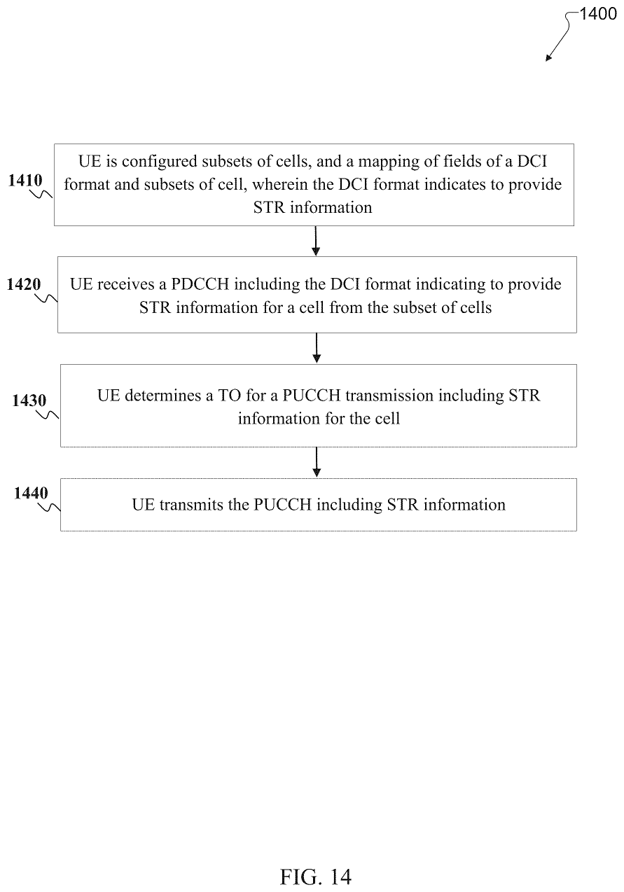

FIG. 14 illustrates a flowchart of an example UE procedure 1400 for transmitting STR reporting including a DCI format indicating STR information according to embodiments of the present disclosure. For example, procedure 1400 for transmitting STR reporting including a DCI format indicating STR information can be performed by the UE 116 of FIG. 3 and a complimentary procedure may be performed by a BS, such as the BS 103 of FIG. 1. This example is for illustration only and other embodiments can be used without departing from the scope of the present disclosure.

The procedure begins in 1410, a UE is configured subsets of cells, and a mapping of fields of a DCI format and subsets of cell, wherein the DCI format indicates to provide STR information. In 1420, the UE receives a PDCCH including the DCI format indicating to provide STR information for a cell from the subset of cells. In 1430, the UE determines a TO for a PUCCH transmission including STR information for the cell. In 1440, the UE transmits the PUCCH including STR information.

With reference to FIG. 14, an example procedure for STR reporting based on an indication at the physical layer is shown.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive:
first information for a first set of operation states for first one or more cells,
second information for a second set of operation states for second one or more cells, wherein an operation state from the first set of operation states or the second set of operation states is associated with sets of parameters for transmissions or receptions in at least one of time, frequency, and spatial domains, and
third information for a resource for transmission of a channel; and
a processor operably coupled to the transceiver, the processor configured to determine:
one or more first operation states from the first set of operation states, and
one or more second operation states from the second set of operation states, wherein:
the transceiver is further configured to transmit the channel using the resource, and
the channel indicates the one or more first operation states and the one or more second operation states.

2. The UE of claim 1, wherein the first information and the second information are provided by UE-specific higher layer signaling.

3. The UE of claim 1, wherein:
the transceiver is further configured to receive:
fourth information for one or more search space sets for receiving physical downlink control channels (PDCCHs), and
the PDCCHs,
a PDCCH of the PDCCHs provides a downlink control information (DCI) format, and
the DCI format includes first and second indexes respectively associated with a first operation state from the first set of operation states and a second operation state from the second set of operation states.

4. The UE of claim 1, wherein:
the transceiver is further configured to receive:
fourth information for one or more search space sets for receiving physical downlink control channels (PDCCHs), and
the PDCCHs,
a PDCCH of the PDCCHs provides a downlink control information (DCI) format,
the DCI format includes a first bit associated with the first one or more cells and a second bit associated with the second one or more cells, and
a value of 0 for the second bit indicates no change to an operation state for a second cell and a value of 1 for the second bit indicates a change to the operation state for the second cell.

5. The UE of claim 4, wherein:
the transceiver is further configured to receive fifth information for a first pair of operation states for the first one or more cells and a second pair of operations states for the second one or more cells, and
for a pair of operation states from the second pair of operation states, the value of 0 for the second bit indicates no change to the operation state for the second cell and the value of 1 for the second bit indicates a change from a current operation state to the other operation state from the pair of operation states for the second cell.

6. The UE of claim 1, wherein:
the transceiver is further configured to receive:
fourth information for one or more search space sets for receiving physical downlink control channels (PDCCHs), and
the PDCCHs,
a PDCCH of the PDCCHs provides a downlink control information (DCI) format that schedules a reception of a physical downlink shared channel (PDSCH), and
the PDSCH includes first and second indexes respectively associated with a first operation state from the first set of operation states and a second operation state from the second set of operation states.

7. The UE of claim 1, wherein:
the transceiver is further configured to receive fourth information associated with transmission occasions (TOs) for the transmission of the channel,
the processor is further configured to determine a TO for the transmission of the channel based on the fourth information, and
the channel is transmitted in the TO.

8. A base station (BS) comprising:
a transceiver configured to transmit:
first information for a first set of operation states for first one or more cells,
second information for a second set of operation states for second one or more cells, wherein an operation state from the first set of operation states or the second set of operation states is associated with sets of parameters for receptions or transmissions in at least one of time, frequency, and spatial domains, and
third information for a resource for reception of a channel; and
a processor operably coupled to the transceiver, the processor configured to determine:
one or more first operation states from the first set of operation states, and
one or more second operation states from the second set of operation states, wherein:
the transceiver is further configured to receive the channel using the resource, and
the channel indicates the one or more first operation states and the one or more second operation states.

9. The BS of claim 8, wherein the first information and the second information are provided by UE-specific higher layer signaling.

10. The BS of claim 8, wherein:
the transceiver is further configured to transmit:
fourth information for one or more search space sets for transmitting physical downlink control channels (PDCCHs), and
the PDCCHs,
a PDCCH of the PDCCHs provides a downlink control information (DCI) format, and
the DCI format includes first and second indexes respectively associated with a first operation state from the first set of operation states and with a second operation state from the second set of operation states.

11. The BS of claim 8, wherein:
the transceiver is further configured to transmit:
fourth information for one or more search space sets for transmitting physical downlink control channels (PDCCHs), and
the PDCCHs,
a PDCCH of the PDCCHs provides a downlink control information (DCI) format,
the DCI format includes a first bit associated with the first one or more cells and a second bit associated with the second one or more cells, and
a value of 0 for the second bit indicates no change to an operation state for a second cell and a value of 1 for the second bit indicates a change to the operation state for the second cell.

12. The BS of claim 8, wherein:
the transceiver is further configured to transmit:
fourth information for one or more search space sets for transmitting physical downlink control channels (PDCCHs), and
the PDCCHs,
a PDCCH of the PDCCHs provides a downlink control information (DCI) format that schedules a transmission of a physical downlink shared channel (PDSCH), and
the PDSCH includes first and second indexes respectively associated with a first operation state from the first set of operation states and a second operation state from the second set of operation states.

13. The BS of claim 8, wherein:
the transceiver is further configured to transmit fourth information associated with transmission occasions (TOs) for the reception of the channel,
the processor is further configured to determine a TO for the reception of the channel based on the fourth information, and
the channel is received in the TO.

14. A method comprising:
receiving:
first information for a first set of operation states for first one or more cells,
second information for a second set of operation states for second one or more cells, wherein an operation state from the first set of operation states or the second set of operation states is associated with sets of parameters for transmissions or receptions in at least one of time, frequency, and spatial domains, and
third information for a resource for transmission of a channel;
determining:
one or more first operation states from the first set of operation states, and
one or more second operation states from the second set of operation states; and
transmitting the channel using the resource,
wherein the channel indicates the one or more first operation states and the one or more second operation states.

15. The method of claim 14, wherein the first information and the second information are provided by UE-specific higher layer signaling.

16. The method of claim 14, further comprising:
receiving:
fourth information for one or more search space sets for receiving physical downlink control channels (PDCCHs), and
the PDCCHs,
wherein:
a PDCCH of the PDCCHs provides a downlink control information (DCI) format, and
the DCI format includes first and second indexes respectively associated with a first operation state from the first set of operation states and a second operation state from the second set of operation states.

17. The method of claim 14, further comprising:
receiving:
fourth information for one or more search space sets for receiving physical downlink control channels (PDCCHs), and
the PDCCHs,
wherein:
a PDCCH of the PDCCHs provides a downlink control information (DCI) format,
the DCI format includes a first bit associated with the first one or more cells and a second bit associated with the second one or more cells, and
a value of 0 for the second bit indicates no change to an operation state for a second cell and a value of 1 for the second bit indicates a change to the operation state for the second cell.

18. The method of claim 17, further comprising:
receiving fifth information for a first pair of operation states for the first one or more cells and a second pair of operations states for the second one or more cells,
wherein, for a pair of operation states from the second pair of operation states, the value of 0 for the second bit indicates no change to the operation state for the second cell and the value of 1 for the second bit indicates a change from a current operation state to the other operation state from the pair of operation states for the second cell.

19. The method of claim 14, further comprising:
receiving:
fourth information for one or more search space sets for receiving physical downlink control channels (PDCCHs), and
the PDCCHs,
wherein:
a PDCCH of the PDCCHs provides a downlink control information (DCI) format that schedules a reception of a physical downlink shared channel (PDSCH), and
the PDSCH includes first and second indexes respectively associated with a first operation state from the first set of operation states and a second operation state from the second set of operation states.

20. The method of claim 14, further comprising:
receiving fourth information associated with transmission occasions (TOs) for the transmission of the channel; and
determining a TO for the transmission of the channel based on the fourth information,
wherein transmitting the channel comprises transmitting the channel in the TO.
